(19) United States
(12) Patent Application Publication
(10) Pub. No.: US 2011/0225038 A1
(43) Pub. Date: Sep. 15, 2011

(54) System and Method for Efficiently Evaluating Complex Boolean Expressions

(75) Inventors: Marcus Fontoura, Mountain View, CA (US); Jayavel Shanmugasundaram, Santa Clara, CA (US); Serguel Vassilvitskii, New York, NY (US); Erik Vee, San Mateo, CA (US); Jason Zien, Mountain View, CA (US)

(73) Assignee: Yahoo! Inc., Sunnyvale, CA (US)

(21) Appl. No.: 12/724,415

(22) Filed: Mar. 15, 2010

(51) Int. Cl. G06F 17/30; G06Q 30/00

(52) U.S. Cl. 705/14.49; 707/711; 707/769; 707/741; 707/E17.108; 707/E17.002

(57) ABSTRACT

An improved system and method for efficiently evaluating complex Boolean expressions is provided. Leaf nodes of Boolean expression trees for objects represented by Boolean expressions of attribute-value pairs may be assigned a positional identifier that indicates the position of a node in the Boolean expression tree. The positional identifiers of each object may be indexed by attribute-value pairs of the leaf nodes of the Boolean expression trees in an inverted index. Given an input set of attribute-value pairs, a list of positional identifiers for leaf nodes of virtual Boolean expression trees may be found in the index matching the attribute-value pairs of the input set. The list of positional identifiers of leaf nodes may be sorted in order by positional identifier for each contract. An expression evaluator may then verify whether a virtual Boolean expression tree for each contract is satisfied by the list of positional identifiers.

### FIELD OF THE INVENTION

The invention relates generally to computer systems, and more particularly to an improved system and method for efficiently evaluating complex Boolean expressions.

### BACKGROUND OF THE INVENTION

The problem of efficiently evaluating a large collection of arbitrarily complex Boolean expressions occurs in many applications including publish/subscribe systems and emerging online advertising applications such as advertising exchanges and automatic targeting. A publish/subscribe system, for instance, may model a subscription as a Boolean expression and may model an event as a collection of attribute-value pairs. Given an assignment of attributes to values for an event, a publish/subscribe system may return subscriptions that match an event. In online display advertising systems, an advertiser campaign can be modeled as a Boolean expression targeting user visit features, and a user visit can be modeled as a collection of attribute-value pairs. Given an assignment of attributes to values for a user visit, an online advertising system may return a set of advertiser campaigns that match the attribute-value pairs assigned to the user visit.

Current solutions for evaluating Boolean expressions, however, are primarily limited to simple Boolean expressions such as conjunctions and conjunctive/disjunctive normal form expressions. See, for example, G. Ashayer, H. K. Y. Leung, and H. -A. Jacobsen, Predicate Matching and Subscription Matching in Publish/Subscribe Systems, In ICDCSW '02, pages 539-548, IEEE Computer Society, Washington, D.C., USA, 2002; and A. Carzaniga and A. L. Wolf, Forwarding in a Content-based Network, In SIGCOMM, pages 163-174, 2003. Conjunctive normal form, CNF, is a Boolean expression of predicates written using an iterated AND operator. An advertising contract specified as a Boolean expression in CNF may thus include any number of attribute-value pairs joined by the AND operator, and the occurrence of all of the attribute-value pairs may satisfy the contract. Disjunctive normal form, DNF, is a Boolean expression of predicates written using an iterated OR operator. An advertising contract specified as a Boolean expression in DNF may thus include any number of attribute-value pairs joined by the OR operator, and the occurrence of any one of the feature-value pairs may satisfy the contract. While these restrictions are functional for many existing applications, some emerging applications require support for arbitrarily complex Boolean expressions, such as advertising exchange. These emerging applications involve arbitrarily complex Boolean expressions where the attribute-value pairs may be joined by either the AND operator and the OR operator.

For example, an advertising exchange is essentially an electronic hub that connects online publishers to advertisers, either directly or through intermediaries. Advertisement contracts may be represented by a list of attribute-value pairs that can be expressed by a Boolean expression. For instance, a list of attribute-value pairs that requires (State, CA), (Gender, Male), and (Age, 30) may be represented by the Boolean expression, ((State, CA) AND (Gender, Male) AND (Age, 30)). An advertiser may also want to specify an advertisement contract that includes negative predicates. For instance, an advertiser may only want to sell to male user visits to Sports pages, and female user visits that are not to Finance pages. This could be represented as a Boolean expression, ((Gender, Male) AND (Category, Sports)) OR ((Gender, Female) AND (Category, NOT-IN Finance)). Since advertisement contracts and attributes of user visits can themselves be complicated DNF or other expressions, conjunctions of such expressions quickly leads to fairly complex Boolean expressions. And the advertisement exchange has to rapidly evaluate complex Boolean expressions to determine which ones satisfy the given assignment of attributes to values.

A related application that generates complex Boolean expressions is automatic user targeting for display advertising. Unlike manual user targeting where advertisers specify the Boolean expression of interest (as in the examples above), in automatic user targeting, the system automatically generates targeting expressions that try to maximize advertiser objectives such as clicks or conversions. For instance, an advertiser who is interested in obtaining clicks on advertisements may specify a fairly broad targeting constraint, and allow the system to explore the high dimensional targeting space to generate Boolean targeting expressions that optimize desired measurement objectives. Clearly these can get quite complex very quickly because they are automatically generated. Given many such advertiser campaigns, the advertising system again needs to rapidly evaluate these Boolean expressions given an attribute assignment of a user visit.

The simple solution of normalizing complex Boolean expressions to DNF or CNF form, and then using existing methods for evaluating such expressions is not always effective because of the exponential blow-up in the size of expressions due to normalization. Another simple method is to convert the Boolean expressions to DNF or CNF form and then using existing methods to evaluate these expressions. Again, this method has the downside of an exponential blow-up in the size the expressions due to normalization. Furthermore, this method may also lead to excessive memory requirements since most online advertising systems are entirely memory-resident for latency reasons.

What is needed is a system and method that may efficiently evaluate Boolean expression given an input assignment of attribute-value pairs. The system and method should allow arbitrarily complex Boolean expressions where the attribute-value pairs may be joined by either the AND operator and the OR operator.

### SUMMARY OF THE INVENTION

Briefly, the present invention may provide a system and method for efficiently evaluating complex Boolean expressions. In various embodiments, a client computer may be operably connected to a search server, a content server and an advertisement server. The advertisement server may be operably coupled to an advertisement serving engine that may include functionality to select one of more advertisements using many different types of features that may match a user visit profile and may serve the advertisements to a client device for display with the search results of query processing or with content requested to be served. Advertisement campaigns may be defined by Boolean expressions targeting user visit features, and the advertising serving engine may be given an assignment of attributes to values for a user visit to serve advertisements for advertisement campaigns that match the attribute-value pairs assigned to the user visit. Accordingly, the advertisement serving engine may include a Boolean expression annotator that may annotate each conjunction of a Boolean expression of attribute-value pairs with a positional identifier of where it occurs in a Boolean expression tree. The advertisement serving engine may also include a conjunction index builder that may generate an inverted index of conjunction annotations for a Boolean expression. The advertisement serving engine may also include an index search engine that may access the inverted index by attribute-value pairs of an input assignment of a Boolean expression of features, for a user visit profile for instance, in order to find conjunction annotations that may satisfy a virtual Boolean expression tree. And the advertisement serving engine may also include an expression evaluator that may determine whether the conjunction annotations found in the inverted index that match the input assignment of attribute-value pairs may satisfy a virtual Boolean expression tree. A list of advertisements for advertisement campaigns that match the attribute-value pairs assigned to the user visit may be sent to the client computer for display on a web page. Upon receiving the advertisements, the client computer may display the advertisements on the web page.

The present invention may model an advertiser campaign as a Boolean expression targeting user visit features, and a user visit can be modeled as a collection of attribute-value pairs. Given an assignment of attributes to values for a user visit, an online advertising system may return a set of advertiser campaigns that match the attribute-value pairs assigned to the user visit. To do so, advertisement contracts represented by Boolean expressions of attribute-value pairs may be received, and Boolean expression trees may be generated for the advertisement contracts represented by Boolean expressions of attribute-value pairs. Leaf nodes of the expression tree may be assigned a positional identifier that indicates the position of the leaf node in the Boolean expression tree. The positional identifiers of each contract may be indexed by attribute-value pairs of the leaf nodes of the Boolean expression trees in an inverted index. Given an input set of attribute-value pairs, a list of positional identifiers for leaf nodes of virtual Boolean expression trees may be found in the index matching the attribute-value pairs of the input set. The list of positional identifiers of leaf nodes may be sorted in order by positional identifier for each contract. An expression evaluator may then verify whether a virtual Boolean expression tree for each contract is satisfied by the list of positional identifiers. And advertisements for the advertisement contracts that are satisfied by the input list of attribute-value pairs may be selected for an online advertising application.

In general, an evaluation algorithm may act recursively on a virtual Boolean expression tree for verifying that a virtual Boolean expression tree of each contract is satisfied by a list of positional identifiers of leaf nodes. As the list of positional identifiers is processed, the portion of the virtual Boolean expression tree where the positional identifiers occur is implicitly traversed. To evaluate a node in the virtual tree that is an ancestor of the leaf node corresponding to an input positional identifier, the algorithm moves down the tree toward that leaf node. When a leaf node is reached, it evaluates to true, since the index only returns those conjunctions which evaluate to true. The algorithm then pops up a level, partially evaluating that node. The current tree node positional identifier is updated to the next positional identifier in the input list. The algorithm continues to pop up levels of the tree, evaluating nodes along the way, until an ancestor of the tree node positional identifier is reached. The algorithm iterates in this manner through the list of positional identifiers in sorted order to evaluate the entire expression.

Advantageously, the present invention may efficiently evaluating complex Boolean expressions, improve indexing speed for arbitrarily complex Boolean expressions, and improve the run time memory performance for evaluating whether objects modeled as Boolean expressions match an input assignment of attribute-value pairs. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components in an embodiment for efficiently evaluating complex Boolean expressions, in accordance with an aspect of the present invention;

FIG. 3 is an illustration depicting in an embodiment an expression tree encoding a Boolean expression of features, in accordance with an aspect of the present invention;

FIG. 4 is a flowchart generally representing the steps undertaken in one embodiment for indexing advertisement contracts represented by Boolean expressions of feature-value pairs encoded as expression trees, in accordance with an aspect of the present invention;

FIG. 5 is a flowchart generally representing the steps undertaken in one embodiment for efficiently finding Boolean expressions satisfied by an input set of attribute name and value pairs, in accordance with an aspect of the present invention;

FIG. 6 is a flowchart generally representing the steps undertaken in one embodiment for efficiently evaluating whether a Boolean expression is satisfied by an input set of attribute name and value pairs, in accordance with an aspect of the present invention; and

FIG. 7 is a flowchart generally representing the steps undertaken in one embodiment for efficiently evaluating an OR node in a virtual Boolean expression tree, in accordance with an aspect of the present invention.

### DETAILED DESCRIPTION

### Exemplary Operating Environment

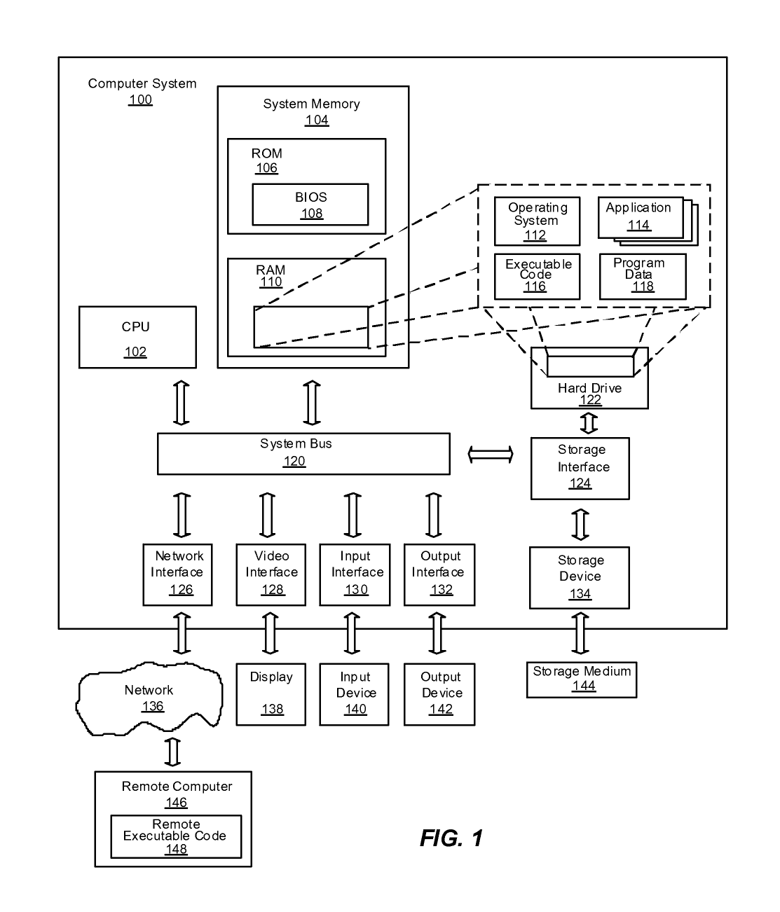

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Efficiently Evaluating Complex Boolean Expressions

The present invention is generally directed towards a system and method for efficiently evaluating complex Boolean expressions. For instance, an advertiser campaign may be modeled as a Boolean expression targeting user visit features, and a user visit can be modeled as a collection of attribute-value pairs. Given an assignment of attributes to values for a user visit, an online advertising system may return a set of advertiser campaigns that match the attribute-value pairs assigned to the user visit. To do so, advertisement contracts represented by Boolean expressions of attribute-value pairs may be received, and Boolean expression trees may be generated for the advertisement contracts represented by Boolean expressions of attribute-value pairs. Leaf nodes of the expression tree may be assigned a positional identifier that indicates the position of the leaf node in the Boolean expression tree. The positional identifiers of each contract may be indexed by attribute-value pairs of the leaf nodes of the Boolean expression trees in an inverted index. Given an input set of attribute-value pairs, a list of positional identifiers for leaf nodes of virtual Boolean expression trees may be found in the index matching the attribute-value pairs of the input set. The list of positional identifiers of leaf nodes may be sorted in order by positional identifier for each contract. An expression evaluator may then verify whether a virtual Boolean expression tree for each contract is satisfied by the list of positional identifiers. And advertisements for the advertisement contracts that are satisfied by the input list of attribute-value pairs may be selected for an online advertising application.

As will be seen, the present invention uses a bottom-up evaluation technique to process only the relevant parts of complex Boolean expressions that contain the matching conjunctions. Each conjunction is annotated with a compact description of where it occurs in the Boolean expressions. And a bottom-up evaluation of Boolean expressions is performed in a single pass over the matching conjunctions and only selectively evaluates the parts of these expressions that have at least one matching conjunction. As will be understood, the various block diagrams, flow charts and scenarios described herein are only examples, and there are many other scenarios to which the present invention will apply.

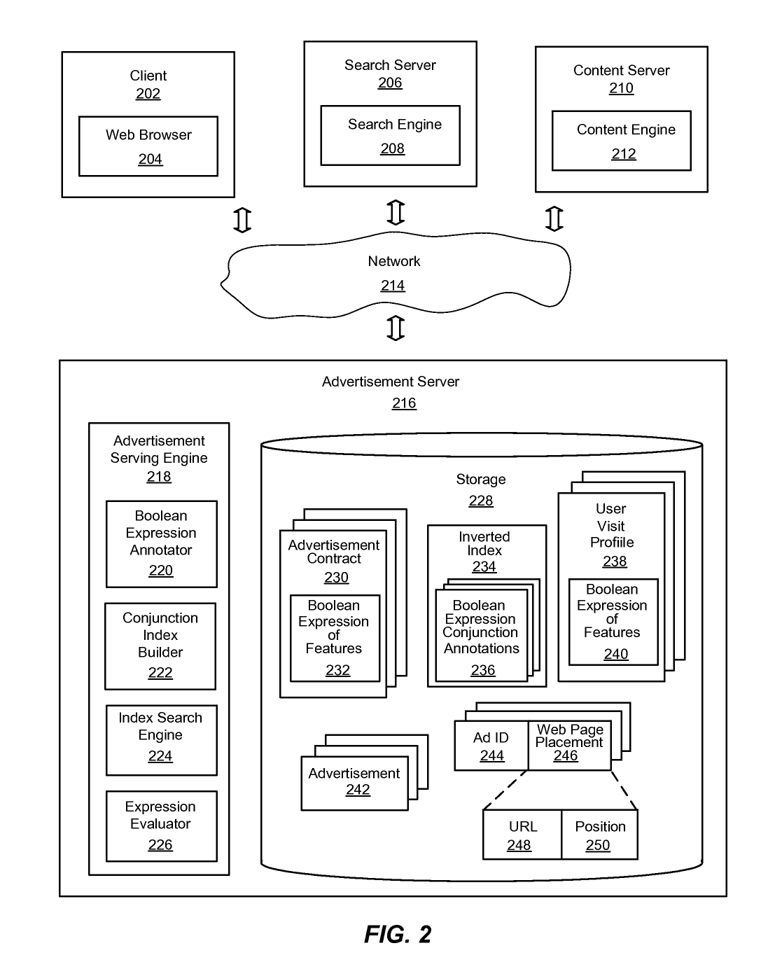

Turning to FIG. 2 of the drawings, there is shown a block diagram generally representing an exemplary architecture of system components for efficiently evaluating complex Boolean expressions. Those skilled in the art will appreciate that the functionality implemented within the blocks illustrated in the diagram may be implemented as separate components or the functionality of several or all of the blocks may be implemented within a single component. For example, the functionality for the Boolean expression annotator 220 may be included in the same component as the conjunction index builder 222. Or the functionality of the Boolean expression annotator 220 may be implemented as a separate component from the conjunction index builder 222 as shown. Moreover, those skilled in the art will appreciate that the functionality implemented within the blocks illustrated in the diagram may be executed on a single computer or distributed across a plurality of computers for execution.

In various embodiments, a client computer 202 may be operably coupled by a network 214 to one or more servers such as an advertisement server 216, a search server 206, or a content server 210. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for requesting, receiving and displaying web pages with a variety of content including text, voice, images, music, video, other multimedia content and so forth. The web browser may also include functionality for receiving a search request which may be input by a user entering a query, functionality for sending the query request to a search engine to obtain a list of search results, and functionality for receiving a list of search results from a server for display by the web browser, for instance, in a search results page on the client device. In general, the web browser 204 may be any type of interpreted or executable software code such as a kernel component, an application program, a script, a linked library, an object with methods, and so forth. The web browser 204 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The search server 206 and the content server 210 may be any type of computer system or computing device such as computer system 100 of FIG. 1. In general, the search server 206 may provide services for receiving a search query, processing the query to retrieve search results, ranking the search results, and sending a ranked list of search results to the web browser 204 executing on the client 202 for display. In particular, the search server 206 may include a search engine 208 that may include functionality for query processing including retrieving search results and ranking the search results. In general, the content server 210 may provide services for receiving a request to serve content such as a web page, retrieving the requested content, and sending the requested content to the web browser 204 executing on the client 202 for display. In particular, the content server 210 may include a content engine 212 that may include functionality for processing the request to serve content including retrieving the content and sending the requested content. The search engine 208 and the content engine 212 may also be any type of executable software code such as a kernel component, an application program, a linked library, an object with methods, or other type of executable software code. These components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The search server 208 may request one or more advertisements to be served from the advertisement server 216 for display with search results. Similarly, the content server 210 may request one or more advertisements to be served from the advertisement server 216 for display with content. The advertisement server 216 may be any type of computer system or computing device such as computer system 100 of FIG. 1. In general, the advertisement server 216 may provide services for sending one or more advertisements to the web browser 204 executing on the client 202 for display with the search results of query processing or with content requested to be served. In particular, the advertisement server 216 may include an advertisement serving engine 218 that may include functionality to select one of more advertisements using many different types of features that may match a user visit profile and may serve the advertisements to the web browser 204 executing on the client 202 for display with the search results of query processing or with content requested to be served. A user visit profile may represent many different features used for finding a matching advertisement for display on a web page.

In specific, an advertiser campaign can be modeled as a Boolean expression targeting user visit features, and a user visit can be modeled as a collection of attribute-value pairs. Given an assignment of attributes to values for a user visit, an online advertising system may return a set of advertiser campaigns that match the attribute-value pairs assigned to the user visit. Accordingly, the advertisement serving engine 218 may include a Boolean expression annotator 220 that may annotate each conjunction of a Boolean expression of attribute-value pairs with a positional identifier of where it occurs in a Boolean expression tree. As used herein, a conjunction means means an expression represented by a set operator, including IN or NOT_IN. Thus a boolean expression may include one or more conjunctions joined by a boolean operator such as AND. In general, the expression annotator 220 may annotate each conjunction of a Boolean expression of attribute-value pairs with a positional identifier for any object that may be represented by a Boolean expression. In specific, advertisement contracts 230, for instance, may include a Boolean expression of features 232 that specifies attribute-value pairs for display of an advertisement to an online user. The Boolean expression annotator 220 may encode a Boolean expression of attribute-value pairs of an advertisement contract as a Boolean expression tree and then annotate each conjunction of a Boolean expression of attribute-value pairs with a positional identifier of where it occurs in a Boolean expression tree. Thus each leaf node of the Boolean expression tree, for instance, that encodes an attribute-value pair may be annotated with a positional identifier. These conjunction annotations for a Boolean expression of an advertisement contract are then stored in storage 228. In an embodiment, these conjunction annotations for a Boolean expression 236 are indexed by a conjunction index builder 222 and are stored in an inverted index 234. In particular, the positional identifiers assigned to each of the leaf nodes of the Boolean expression trees encoding attribute-value pairs may be indexed by attribute-value pairs of the leaf nodes of the Boolean expression trees in the inverted index as lists of contract-positional identifier pairs in sorted order. For example, (c1, posID))->(c2 posID) may represent a list of contract-posID pairs in sorted order for an attribute-value pair.

The advertisement serving engine 218 may additionally include a conjunction index builder 222 that may generate an inverted index 234 of conjunction annotations for a Boolean expression 236. The advertisement serving engine 218 may also include an index search engine 224 that may access the inverted index by attribute-value pairs of an input assignment of a Boolean expression of features 240, for a user visit profile 238 for instance, in order to find conjunction annotations that may satisfy a virtual Boolean expression tree, and the advertisement serving engine 218 may also include an expression evaluator 226 that may determine whether the conjunction annotations found in the inverted index of conjunction annotations that match the input assignment of attribute-value pairs may satisfy a virtual Boolean expression tree. In an embodiment, conjunction annotations that match an input assignment of attribute-value pairs for a user visit profile 238 may be found in the inverted index 234 and verified that they may satisfy one or more virtual Boolean expression trees each encoding an advertisement contract. Each of these components, the Boolean expression annotator 220, the conjunction index builder 222, the index search engine 224, and the expression evaluator 226, may also be any type of executable software code such as a kernel component, an application program, a linked library, an object with methods, or other type of executable software code. These components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The advertisement server 216 may be operably coupled to storage 228 that may store advertisement contracts 230, each including a Boolean expression conjunction annotations 236, an inverted index 234 of Boolean expression trees 234, and user visit profiles 238, each including a Boolean expression of features 240. The storage 228 may also store advertisements 242. In an embodiment, an advertisement 242 may be displayed according to a web page placement 246. An advertisement 242 may be associated with an advertisement ID 244 stored in storage 228 with an allocated web page placement 246 that may include a Uniform Resource Locator (URL) 248 for a web page and a position 250 for displaying an advertisement on the web page. As used herein, a web page placement may mean a location on a web page designated for placing an advertisement for display. In various embodiments, a web page may be any information that may be addressable by a URL, including a document, an image, audio, and so forth.

There are many applications that may use the present invention to efficiently compare Boolean expressions of features to find matching attributes. For example, online content publishing applications may use the present invention to select a list of advertisements that match the user visit profile associated with a web page for display with content requested by a user. Similarly, ecommerce applications may use the present invention to select a list of products that match the attributes of product information requested by a user and may also use the present invention to select a list of advertisements that match the attributes of product information requested by a user. Or online search advertising applications may use the present invention to select a list of advertisements that match the user visit profile associated with a web page for display with search results requested by a user. For any of these online applications, Boolean expressions of features may be efficiently evaluated by the present invention given an input assignment of features. In the case of an online search advertising application such as an online keyword search auction, attributes used by the present invention for an input assignment of features may be obtained from a query, advertiser texts and its semantic content, the user's attributes including intent, demographic and geographic information, click history and so forth.

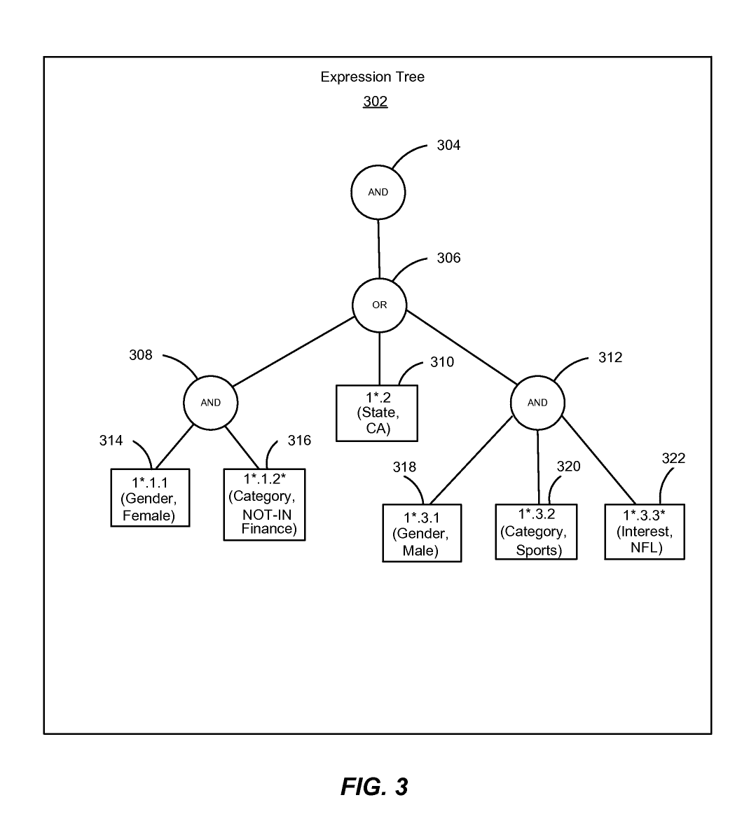

FIG. 3 depicts in an embodiment an expression tree encoding a Boolean expression of features. Advertising contracts may be represented by a list of attribute-value pairs that can be expressed by a Boolean expression. For instance, a list of attribute-value pairs that requires the two attributes (Gender, Female) and (Category, NOT-IN Finance), or the one attribute (State, CA), or the three attributes (Gender, Male), (Category, Sports), and (Interest, NFL) may be represented by the Boolean expression ((Gender, Female) AND (Category, NOT-IN Finance)) OR (State, CA) OR ((Gender, Male) AND (Category, Sports) AND (Interest, NFL)). Any advertisement contract of attribute-value pairs may be expressed as an arbitrary Boolean expression where the attribute-value pairs may be joined by either the AND operator and the OR operator. The arbitrarily complex Boolean expression may then be represented by an expression tree with alternating AND and OR non-leaf nodes.

In the embodiment illustrated in FIG. 3 for example, node 304 may be a root node of the Boolean expression tree 302. Note that the root node has a value of an AND operator and that each non-leaf node at even levels of the expression tree has the value of an AND operator. For instance, non-leaf nodes 308 and 312 at level 2 of the tree, each have the value of the AND operator. Also note that each non-leaf node at odd levels of the tree has the value of an OR operator. For instance, non-leaf node 306 at level 1 of the tree has the value of the OR operator. Each leaf node of the expression tree 302 may be assigned an attribute-value pair. For example, leaf nodes 310, 314, 316, 318, 320, and 322 are each respectively assigned an attribute-value pair, (State, CA), (Gender, Female), (Category, NOT-IN Finance), (Gender, Male), (Category, Sports) and (Interest, NFL).

Each leaf node may further be encoded with a positional number that indicates the position of the attribute-value pair in the expression tree. In an embodiment, a Dewey identifier may be used as a positional number that indicates the position of the attribute-value pair in the expression tree. For example, the positional number of the root node may be null in an embodiment. Nodes that are children of the same node are then consecutively numbered from left to right, and each of these numbers is appended to the positional number of their parent to assign the positional numbers to the children. In various embodiments, the children of a node be sequentially numbered starting from 1, with the last child marked with a special symbol *, and a decimal may be inserted before appending the number of a child to the positional number of the parent. The root-to-node numbering based on those edge numbers is referred to as the Dewey ID of a node. The length of a Dewey ID is the number of edges from the root to the node. Observe that a node with an odd length Dewey ID is beneath an AND, and a node with an even length Dewey ID is beneath an OR. In general, the positional number of a node in the expression tree is the positional number of its parent node appended with the number of its position in the sequence of children nodes of its parent node that are consecutively numbered from left to right. Thus, each position separated by a decimal in the positional number represents the level of the node in the expression tree. Note that the root node is an AND node. Also note that AND nodes may have either an OR node as a child or a leaf node as a child. Furthermore, note that an OR node may have either an AND node as a child or a leaf node as a child. As a result, AND nodes occur on even levels of the expression tree such as levels 2, 4, 6 and so forth; and OR nodes occur on odd levels of the expression tree such as levels 1, 3, 5 and so forth. The length of a node's positional number is equal to the level where it occurs. Moreover, those skilled in the art will appreciate that negative predicate of an attribute-value pair may be included in a Boolean expression, such as (State, NOT-IN CA).

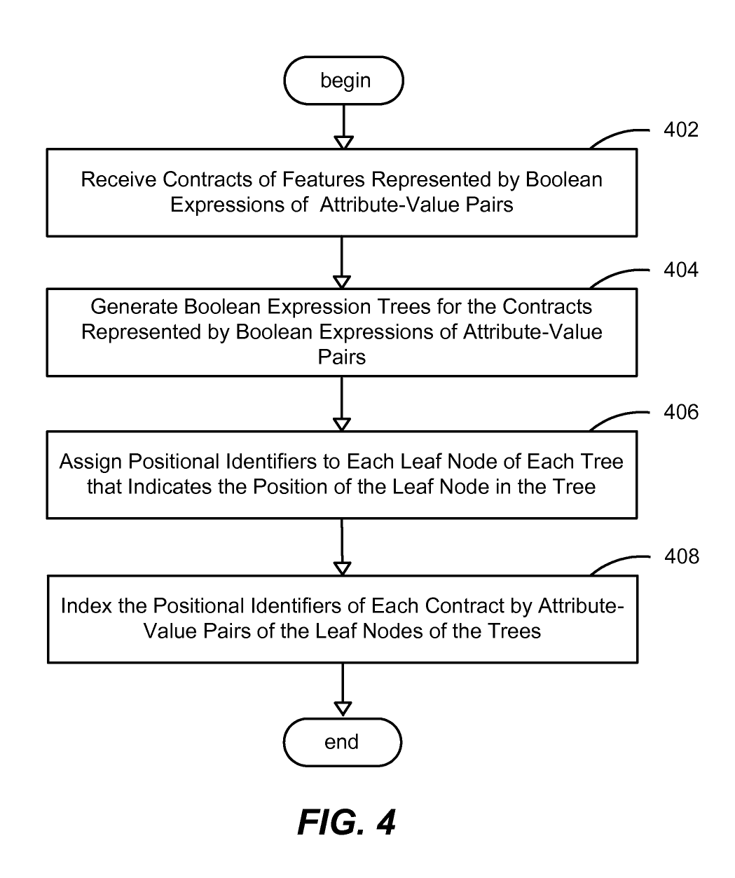

FIG. 4 presents a flowchart generally representing the steps undertaken in one embodiment for indexing advertisement contracts represented by Boolean expressions of feature-value pairs encoded as expression trees. At step 402, advertisement contracts represented by Boolean expressions of attribute-value pairs may be received. At step 404, Boolean expression trees may be generated for the advertisement contracts represented by Boolean expressions of attribute-value pairs. For example the Boolean expression of attribute-value pairs may be encoded as a Boolean expression tree with leaf nodes as illustrated by FIG. 3. As used herein, a Boolean expression tree is a tree in which intermediate nodes, or non-leaf nodes, are of two types: AND nodes and OR nodes. Leaf nodes in the tree may be simple conjunctions of basic ∈ and ∉ predicates in an embodiment. The predicate State ∈ {CA;NY}, for example, means that the state can either be California or New York while the predicate State ∉ {CA;NY} means the state cannot be either of the two states. Notice that the ∈ and ∉ primitives subsume simple = and ≠ predicates. Any Boolean expression can be represented in these AND/OR trees with conjunction leaf nodes. These Boolean expression trees can be arbitrarily complex, including Boolean expression in disjunctive normal form (DNF), in conjunctive normal form (CNF), and combinations such as ANDs of DNFs, ORs of CNFs, and so on.

At step 406, leaf nodes of the expression tree may be assigned a positional identifier that indicates the position of the leaf node in the Boolean expression tree. In various embodiments, the children of a node be sequentially numbered starting from 1, with the last child marked with a special symbol *, and a decimal may be inserted before appending the number of a child to the positional number of the parent. The root-to-node numbering based on those edge numbers is referred to as the Dewey ID of a node.

At step 408, positional identifiers of each contract may be indexed by attribute-value pairs of the leaf nodes of the Boolean expression trees. In an embodiment, positional identifiers of each contract may be indexed by attribute-value pairs of the leaf nodes of the Boolean expression trees in an inverted index as lists of contract-positional ID pairs in sorted order. For example, (c1, posID))->(c2, posID) may represent a list of contract-positional ID pairs in sorted order for an attribute-value pair. Once the positional identifiers of each contract may be indexed by attribute-value pairs of the leaf nodes of the Boolean expression trees in an inverted index, a list of positional identifiers for leaf nodes of virtual Boolean expression trees may be found in the index matching an input set of attribute-value pairs.

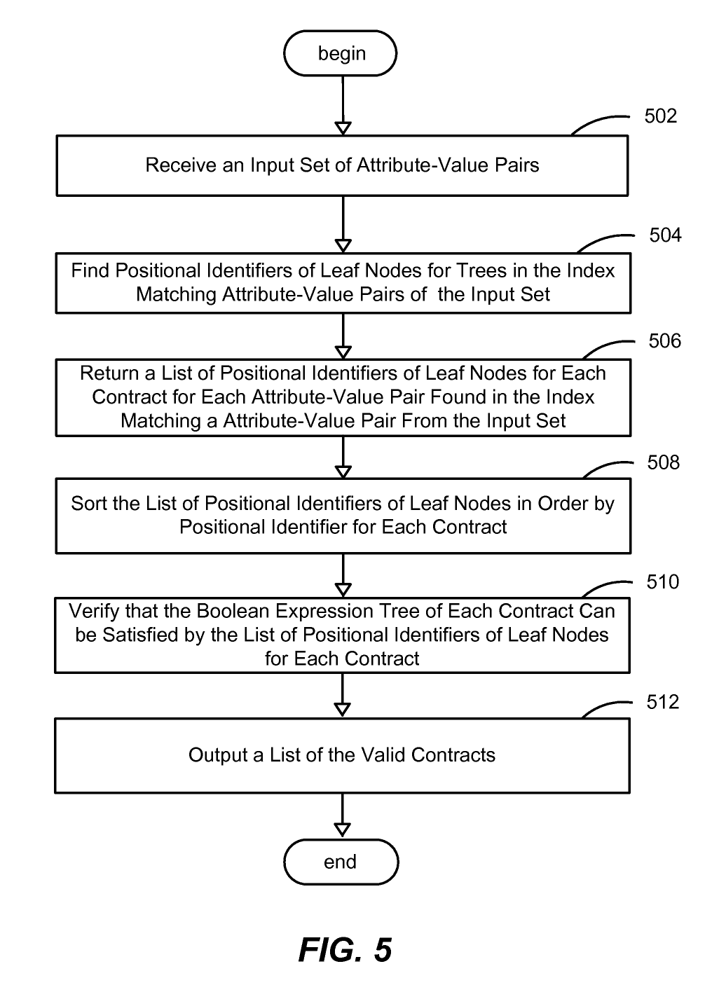

FIG. 5 presents a flowchart generally representing the steps undertaken in one embodiment for efficiently finding Boolean expressions satisfied by an input set of attribute name and value pairs. For instance, advertisements for matching advertisement contracts represented by a large set of Boolean expressions may be efficiently found that are satisfied by an input set of attribute name and value pairs. An input set is a set of attribute name and value pairs {A1=v1;A2=v2, . . . }. At step 502, an input set of attribute-value pairs may be received. For example, a woman in California may have assigned {Gender=F; State=CA} as an input set. At step 504, positional identifiers for leaf nodes of virtual Boolean expression trees may be found in the index matching the attribute-value pairs of the input set.

At step 506, a list of positional identifiers of leaf nodes for each contract may be returned for each of the attribute-value pair found in the index matching an attribute-value pair from the input set. The list of positional identifiers of leaf nodes may be sorted at step 508 in order by positional identifier for each contract. At step 510, it may be verified whether a virtual Boolean expression tree of each contract is satisfied by a list of positional identifiers of leaf nodes for each contract. In an embodiment, an evaluation algorithm may use a bottom-up approach to determine whether a virtual Boolean expression tree of each contract is satisfied by a list of positional identifiers of leaf nodes for each contract. The bottom-up evaluation technique may process only the relevant parts of complex Boolean expressions that contain the matching conjunctions.

At step 512, a list of valid advertisement contracts may be output. And advertisements for the advertisement contracts that match the input list of attribute-value pairs may be selected for an online advertising application. For instance, a list of advertisements may be selected that match the attribute-value pairs of a user visit profile associated with a web page for display with content requested by a user. Or a list of advertisements may be selected that match the feature-value pairs of a web page profile associated with a web page for display with search results requested by a user.

Those skilled in the art will appreciate that an input set of attribute name and value pairs does not necessarily specify all the possible attributes. Allowing unspecified attributes is important to support high-dimensional data where the number of attributes may be in the order of hundreds. Consequently, an assignment of attribute-value pairs to an input set is not restricted in the present invention to a fixed set of possible attributes known in advance.

In general, an evaluation algorithm may act recursively on a virtual Boolean expression tree for verifying that a virtual Boolean expression tree of each contract is satisfied by a list of positional identifiers of leaf nodes. Note that it is not required in an embodiment for the Boolean expression tree to be actually available during online processing. There may be only the list of matching positional identifiers of leaf nodes for each contract. However, the list of matching positional identifiers of leaf nodes implicitly encodes the portion of the Boolean expression tree where the positional identifiers lie. As the positional identifiers are processed, a virtual Boolean expression tree is created on the fly.

It is helpful to imagine a depth-first traversal of the virtual nodes of the Boolean expression tree and a bottom-up evaluator uses a stack-based algorithm to efficiently find the positional identifiers of the Boolean expression that evaluate to true. To evaluate a node in the virtual tree that is an ancestor of the leaf node corresponding to an input positional identifier, the algorithm moves down the tree toward that leaf node. When a leaf node is reached, it evaluates to true, since the index only returns those conjunctions which evaluate to true. The algorithm then pops up a level, partially evaluating that node. The current tree node positional identifier is updated to the next positional identifier in the input list. The algorithm continues to pop up levels of the tree, evaluating nodes along the way, until an ancestor of the tree node positional identifier is reached. The algorithm iterates in this manner through the list of positional identifiers in sorted order to evaluate the entire expression.

Throughout the running of the algorithm, there are alternate calls to an EvaluateAND routine and an EvaluateOR routine. Each call takes as a parameter a tree node positional identifier, which is named dewLabel in the pseudo-code below. Consider each call as corresponding to exploring a node in the virtual Boolean expression tree, and the tree node positional identifier corresponds precisely to the positional identifier of that node. A call to EvaluateAND corresponds to exploring an AND node of the tree, while EvaluateOR corresponds to exploring an OR node.

The following pseudo-code may represent the initialization algorithm in an embodiment for evaluating whether a Boolean expression tree is satisfied by a list of positional identifiers:

Evaluation Algorithm

```
1. Initialize curr ← deweyList.getFirst( ) {a list of
  dewey identifiers in sorted order}
2. Call EvaluateAND (Empty deweyId) {returns true or
  false}
```

The algorithm is initialized by setting “curr”, which corresponds to a leaf node in the virtual Boolean expression tree, to the first element in the sorted list of positional identifiers such as deweyIDs. It then calls Evaluate-AND with Empty DeweyID as the value for the input parameter of a tree node positional identifier to move to the root node of the Boolean expression tree.

The following pseudo-code may represent the main algorithm in an embodiment for evaluating whether a Boolean expression tree is satisfied by a list of positional identifiers:

EvaluateAND Algorithm(dewLabel)

```
1.  if dewLabel = curr then {at a leaf node}
2.  return true
3.  endif
4.  Initialize result ← true, lastExplored ← 0, and
  lastChild ← false
5.  While dewLabel is a prefix for curr do {curr is a
  descendant of this node}
6.  Let child ← Child(dewLabel, curr)
7.  lastExplored ← lastExplored + 1
8.  if Last(child) ≠ lastExplored then
9.  result ← false
10.  endif
11.  lastChild ← Marked(child)
12.  result ← result [symbol]  EvaluateOR(child)
13.  curr ← deweyList.next( )
14. end while
15. curr ← deweyList.prev( )
16. return result [symbol]  lastChild
```

Note that the EvaluateAnd algorithm uses several helper functions. First, Child, which takes as input a prefix of a positional identifier and a positional identifier, such as a dewey ID. The input prefix must be a prefix of the input positional identifier. It returns the positional identifier of entry where the input prefix and positional identifier first differ. For example, Child(0.1.2, 0.1.2.3.4) returns 0.1.2.3. Note that Child returns the positional identifier for one of the children of the prefix of the positional identifier. The other two functions, work on the positional identifiers, LAST returns the value of the last identifier of a positional identifier. For example Last(0.1.2) returns 2. Finally, Marked returns true if the last node of the positional identifier is marked with a * and false otherwise.

Lines 1-3 of the pseudo-code handle the case where the tree node positional indicator is at a leaf node. In this case, the algorithm returns true since the index only returns those conjunctions which evaluate to true. The while loop of lines 5-14 of the pseudo-code iterates through the ancestors in the input list of positional identifiers of the node currently being explored. The child under which the curr positional identifier lies is first evaluated and then EvaluateOR is recursively invoked with its positional identifier corresponding to the child of the currently evaluated node of the virtual Boolean expression tree. After this evaluation takes place, its result is joined by Boolean AND with the result so far. Note that curr may have been updated during the EvaluateOR call. The algorithm continues to iterate through each of the children while curr is a descendant of the node of the virtual Boolean expression tree. Note that in the call to EvaluateAND, a check that a child is not skipped is implemented at lines 7-10 to ensure that every child is explored by maintaining the status indicator lastExplored. The algorithm also implements a check at line 11 that the last child marked with a special symbol * is evaluated along the way.

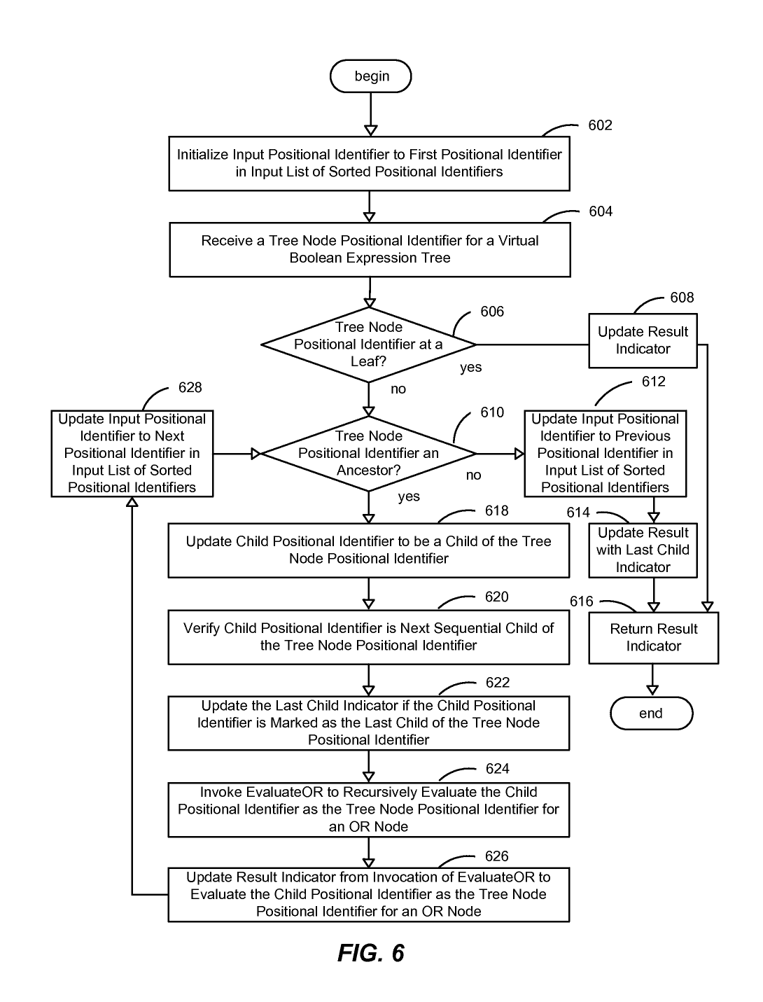

FIG. 6 presents a flowchart generally representing the steps undertaken in one embodiment for efficiently evaluating whether a Boolean expression is satisfied by an input set of attribute name and value pairs. For instance the steps of FIG. 6 may implement the pseudo-code for the EvaluateAND algorithm described above in an embodiment. At step 602, an input positional identifier may be initialized to the first positional identifier in the input list of sorted positional identifiers. Each positional identifier may be a positional number assigned to leaf nodes of a boolean expression tree of a Boolean expression for an advertisement contract in an embodiment. At step 604, a tree node positional identifier may be received for a virtual Boolean expression tree.

And it may be determined at step 606 whether the tree node positional identifier is at a leaf node of the virtual Boolean expression tree. If so, then a result indicator may be updated to true at step 608, and the result indicator may be returned to the caller at step 616. Otherwise, if it may be determined that the tree node positional identifier is not at a leaf node of the virtual Boolean expression tree, then it may be determined at step 610 whether the tree node positional identifier is an ancestor of the input positional identifier. If not, then the input positional identifier may be updated at step 612 to the previous input positional identifier in the input list of sorted input positional identifiers; a result indicator may be updated with the value of a last child indicator at step 614, and the result indicator may be returned to the caller at step 616.

If it may be determined at step 610 that the tree node positional identifier is an ancestor of the input positional identifier, then a child positional identifier may be updated to be a child of the tree node positional identifier at step 618. At step 620, the child positional identifier may be verified to be the next sequential child of the tree node positional identifier. And a last child indicator may be updated at step 622 with a value of true if the child positional identifier may be marked as the last child of the tree node positional identifier.

At step 624, an EvaluateOR recursive routine may be invoked to recursively evaluate the child positional identifier as the tree node positional identifier for an OR node of the virtual Boolean expression tree. At step 626, the result indicator may be updated with the result returned from invocation of the EvaluateOR recursive routine to evaluate the child positional identifier as the tree node positional identifier for an OR node of the virtual Boolean expression tree. And at step 628, the input positional identifier may be updated to the next positional identifier in the input list of sorted positional identifiers, and processing continues at step 610 where it may be determined whether the tree node positional identifier is an ancestor of the input positional identifier.

The following pseudo-code may represent the EvaluateOR algorithm in an embodiment:

EvaluateOR Algorithm(dewLabel)

| | |
|---|---|
| 1. | if dewLabel = curr then {at a leaf node} |
| 2. | return true |
| 3. | endif |
| 4. | Initialize result ← false |
| 5. | While dewLabel is a prefix for curr do {curr is a |
| | descendant of this node} |
| 6. | Let child ← Child(dewLabel, curr) |
| 7. | result ← result [symbol] EvaluateAND(child) |
| 8. | curr ← deweyList.next( ) |
| 9. | end while |
| 10. | curr ← deweyList.prev( ) |
| 11. | return result |

Note that the EvaluateAnd algorithm uses several helper functions.

Lines 1-3 of the pseudo-code handle the case where the tree node positional indicator is at a leaf node. In this case, the algorithm returns true since the index only returns those conjunctions which evaluate to true. The while loop of lines 5-9 of the pseudo-code iterates through the ancestors in the input list of positional identifiers of the node currently being explored. The child under which the curr positional identifier lies is first evaluated and then EvaluateAND is recursively invoked with its positional identifier corresponding to the child of the currently evaluated node of the virtual Boolean expression tree. After this evaluation takes place, its result is joined by Boolean OR with the result so far. Note that curr may have been updated during the EvaluateAND call. The algorithm continues to iterate through each of the children while curr is a descendant of the node of the virtual Boolean expression tree.

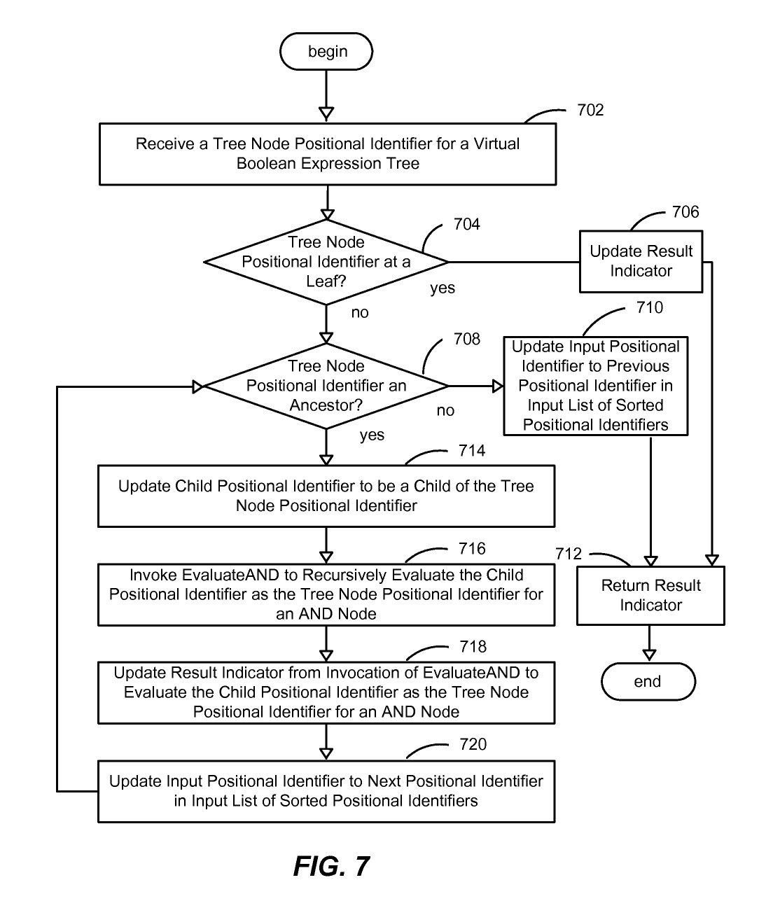

FIG. 7 presents a flowchart generally representing the steps undertaken in one embodiment for efficiently evaluating an OR node in a virtual Boolean expression tree. For instance the steps of FIG. 7 may implement the pseudo-code for the EvaluateOR algorithm described above in an embodiment. At step 702, a tree node positional identifier may be received for a virtual Boolean expression tree. It may be determined at step 704 whether the tree node positional identifier is at a leaf node of the virtual Boolean expression tree. If so, then a result indicator may be updated to true at step 706, and the result indicator may be returned to the caller at step 712.

Otherwise, if it may be determined that the tree node positional identifier is not at a leaf node of the virtual Boolean expression tree, then it may be determined at step 708 whether the tree node positional identifier is an ancestor of the input positional identifier. If not, then the input positional identifier may be updated at step 710 to the previous input positional identifier in the input list of sorted input positional identifier, and the result indicator may be returned to the caller at step 712. If it may be determined at step 708 that the tree node positional identifier is an ancestor of the input positional identifier, then a child positional identifier may be updated to be a child of the tree node positional identifier at step 714.

At step 716, the EvaluateAND recursive routine may be invoked to recursively evaluate the child positional identifier as the tree node positional identifier for an AND node of the virtual Boolean expression tree. For example, the EvaluateAND recursive routine described in conjunction with FIG. 6 may be invoked to recursively evaluate the child positional identifier as the tree node positional identifier for an AND node of the virtual Boolean expression tree. At step 718, the result indicator may be updated with the result returned from invocation of the EvaluateOR recursive routine to evaluate the child positional identifier as the tree node positional identifier for an OR node of the virtual Boolean expression tree. And the input positional identifier may be updated to the next positional identifier in the input list of sorted positional identifiers at step 720, and processing continues at step 708 where it may be determined whether the tree node positional identifier is an ancestor of the input positional identifier.

Given the positional identifiers for nodes A, D, E, and F in FIG. 3, the evaluation algorithm will return true that the list of positional identifiers satisfies the virtual Boolean expression tree of FIG. 3. For example, the following input list of positional identifiers may be received: 1*.1.1, 1*.3.1, 1*.3.2, 1*.3.3*. The evaluation algorithm first looks at input positional identifier 1*.1.1, and recursively calls EvaluateAND and EvaluateOR until it reaches the leaf node(A) of the virtual Boolean expression tree. It then pops up a level to the AND node of the virtual Boolean expression tree at position 1*.1 and increments curr. Since the next positional identifier, 1*.3.1 does not have 1*.1 as a prefix, the evaluation stops, and the AND node of the virtual Boolean expression tree is evaluated to false since the lastChild was never set to true.

The evaluation algorithm then proceeds to evaluate the AND node of the virtual Boolean expression tree at position 1*.3. It successfully evaluates all of the leaves, including the last virtual leaf node, 1*.3.3*, and sets lastChild to true since the positional identifier ends in the special symbol *. The result is then set to true. Consequently, the result of the OR node of the virtual Boolean expression tree at position 1* is set to true as well. Finally, the original call to EvaluateAND returns with a value of true.

Thus the present invention may efficiently evaluate complex Boolean expressions. First, leaf-level conjunctions of the un-normalized Boolean expressions are annotated with a compact description of where they each occur in the Boolean expressions. Then leaf-level conjunctions that match a given input assignment of attribute-value pairs are identified for the Boolean expressions. The matching conjunctions along with the information on where they occur is used to perform a bottom-up evaluation of the Boolean expressions. The bottom-up evaluation is performed in a single pass over the matching conjunctions, and only selectively evaluates the parts of these Boolean expressions that have at least one matching conjunction. Importantly, the present invention may find matching conjunctions and evaluate Boolean expressions without blowing up the size of the expressions and without explicitly evaluating all expressions by using selective bottom-up evaluation of only those parts of expressions that can possibly be satisfied.

As can be seen from the foregoing detailed description, the present invention provides an improved system and method for efficiently evaluating arbitrarily complex Boolean expressions. Leaf nodes of Boolean expression trees for objects represented by Boolean expressions of attribute-value pairs may be assigned a positional identifier that indicates the position of a node in the Boolean expression tree. The positional identifiers of each object may be indexed by attribute-value pairs of the leaf nodes of the Boolean expression trees in an inverted index. Given an input set of attribute-value pairs, a list of positional identifiers for leaf nodes of virtual Boolean expression trees may be found in the index matching the attribute-value pairs of the input set. The list of positional identifiers of leaf nodes may be sorted in order by positional identifier for each object. An expression evaluator may then verify whether a virtual Boolean expression tree for each object is satisfied by the list of positional identifiers. Advantageously, the techniques of the present invention are efficient and scalable, both with respect to space usage as well as evaluation time. As a result, the system and method provide significant advantages and benefits needed in contemporary computing and in online advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for evaluating Boolean expressions, comprising:
an index search engine that accesses an index by each of a plurality of attribute-value pairs to retrieve a plurality of positional identifiers for the plurality of attribute-value pairs to find a plurality of objects each represented by a Boolean expression of at least one of the plurality of attribute-value pairs, each of the plurality of positional identifiers indicating a position of a node in a plurality of virtual Boolean expression trees that each encode the plurality of objects each represented by the Boolean expression of the at least one of the plurality of attribute-value pairs;
an expression evaluator operably coupled to the index search engine that determines whether the plurality of positional identifiers found in the index for the plurality of attribute-value pairs satisfy a virtual Boolean expression tree of at least one of the plurality of objects; and
a storage operably coupled to the index search engine that stores the index with each of the plurality of positional identifiers for each of the plurality of attribute-value pairs in sorted order by at least one object identifier of the plurality of objects.

2. The system of claim 1 further comprising an index builder operably coupled to the storage that generates the index with each of the plurality of positional identifiers for each of the plurality of attribute-value pairs in sorted order by the at least one object identifier of the plurality of objects.

3. The system of claim 1 further comprising an expression annotator operably coupled to the storage that assigns each of the plurality of positional identifiers indicating the position of the node in the plurality of virtual Boolean expression trees that each encode the plurality of objects each represented by the Boolean expression of the at least one of the plurality of attribute-value pairs.

4. The system of claim 1 further comprising an advertisement serving engine operably coupled to the storage that serves one or more advertisements of at least one of a plurality of advertisement contracts encoded as one of the plurality of objects with the plurality of positional identifiers indicating the position of the node in the plurality of virtual Boolean expression trees for which the plurality of positional identifiers found in the index for the plurality of attribute-value pairs satisfy the virtual Boolean expression tree of the at least one of the plurality of objects.

5. The system of claim 4 further comprising a web browser operably coupled to the advertisement serving engine that displays at a web page location on a client device the one or more advertisements of the plurality of advertisement contracts that match the Boolean expression of the plurality of feature-value pairs.

6. A computer-implemented method for evaluating Boolean expressions, comprising:
receiving a plurality of attribute-value pairs;
retrieving a plurality of positional identifiers for the plurality of attribute-value pairs from an index accessed by each of the plurality of attribute-value pairs, each of the plurality of positional identifiers indicating a position of a node in a plurality of virtual Boolean expression trees that each encode a plurality of objects each represented by a Boolean expression of at least one of the plurality of attribute-value pairs;
verifying that at least one of the plurality of positional identifiers satisfy a virtual Boolean expression tree of at least one of the plurality of objects from the plurality of the virtual Boolean expression trees that encode each of the plurality of objects; and
outputting the identification of the at least one of the plurality of objects.

7. The method of claim 6 further comprising accessing the index by each of the plurality of attribute-value pairs to retrieve the plurality of positional identifiers for the plurality of attribute-value pairs.

8. The method of claim 6 further comprising sorting the plurality of positional identifiers in order by value of each of the plurality of positional identifier for each of the plurality of objects.

9. The method of claim 6 wherein verifying that the at least one of the plurality of positional identifiers satisfy the virtual Boolean expression tree of the at least one of the plurality of objects from the plurality of the virtual Boolean expression trees that encode each of the plurality of objects comprises evaluating a node of the virtual Boolean expression tree assigned a logical conjunction.

10. The method of claim 9 wherein evaluating the node of the virtual Boolean expression tree assigned the logical conjunction comprises recursively invoking a first routine for evaluating a child node of the virtual Boolean expression tree assigned a logical disjunction.

11. The method of claim 10 wherein evaluating the child node of the virtual Boolean expression tree assigned the logical disjunction comprises recursively invoking a second routine to evaluate a grandchild node of the virtual Boolean expression tree assigned another logical conjunction.

12. The method of claim 6 wherein verifying that the at least one of the plurality of positional identifiers satisfy the virtual Boolean expression tree of the at least one of the plurality of objects from the plurality of the virtual Boolean expression trees that encode each of the plurality of objects comprises evaluating a plurality of nodes of the virtual Boolean expression tree assigned a logical conjunction and a plurality of node of the virtual Boolean expression tree assigned a logical disjunction.

13. The method of claim 6 further comprising serving at least one advertisement of a plurality of advertisement contracts encoded with the plurality of positional identifiers each indicating the position of the node in the plurality of virtual Boolean expression trees for which at least one of the plurality of positional identifiers satisfy a virtual Boolean expression tree.

14. The method of claim 6 further comprising receiving the plurality of objects each represented by the Boolean expression of the at least one of the plurality of attribute-value pairs and generating a Boolean expression tree with at least one leaf node of the at least one of the plurality of attribute-value pairs for each of the plurality of objects from the Boolean expression of the at least one of the plurality of attribute-value pairs.

15. The method of claim 14 further comprising assigning at least one of the positional identifiers to the at least one leaf node of the at least one of the plurality of attribute-value pairs for the Boolean expression tree.

16. The method of claim 15 further comprising indexing the at least one of the positional identifiers in the index by the at least one of the plurality of attribute-value pairs of the at least one leaf nodes of the Boolean expression tree.

17. The method of claim 14 wherein receiving the plurality of objects each represented by the Boolean expression of the at least one of the plurality of attribute-value pairs comprises receiving a plurality of advertising contracts each represented by the Boolean expression of the at least one of the plurality of attribute-value pairs.

18. A computer-readable storage medium having computer-executable instructions for performing the method of claim 6.

19. A computer system for evaluating Boolean expressions, comprising:
means for indexing a plurality of positional identifiers assigned to a plurality of nodes in a plurality of virtual Boolean expression trees that each encode a plurality of objects each represented by a Boolean expression of a plurality of attribute-value pairs;
means for receiving at least one of the plurality of attribute-value pairs;
means for retrieving at least one of the plurality of positional identifiers for the at least one of the plurality of attribute-value pairs from an index;
means for verifying that the at least one of the plurality of positional identifiers satisfy at least one virtual Boolean expression tree of the plurality of virtual Boolean expression trees that each encode the plurality of objects each represented by the Boolean expression of the plurality of attribute-value pairs; and
means for outputting the identification of at least one of the plurality of objects for which the at least one of the plurality of positional identifiers that satisfy the at least one virtual Boolean expression tree.

20. The computer system of claim 19 further comprising:
means for selecting at least one of a plurality of advertisements from verifying that the at least one of the plurality of positional identifiers satisfy the at least one virtual Boolean expression tree of the plurality of virtual Boolean expression trees that each encode the plurality of objects each represented by the Boolean expression of the plurality of attribute-value pairs; and
means for serving the at least one of the plurality of advertisements for display on a client device.
